(19) United States
(12) Patent Application Publication
(10) Pub. No.: US 2014/0171613 A1
(43) Pub. Date: Jun. 19, 2014

(54) PROCESS FOR THE PRODUCTION OF POLYETHERIMIDES

(71) Applicant: SABIC INNOVATIVE PLASTICS IP B.V., Bergen op Zoom (NL)

(72) Inventors: Bryan Stegall, New Harmony, IN (US); Robert Werling, Evansville, IN (US)

(73) Assignee: SABIC INNOVATIVE PLASTICS IP B.V., Bergen op Zoom (NL)

(21) Appl. No.: 13/718,221

(22) Filed: Dec. 18, 2012

(51) Int. Cl. C08G 73/00

(52) U.S. Cl. CPC C08G 73/00
USPC 528/207

(57) ABSTRACT

A process for preparing polyetherimides at higher production rates and a liquid reaction mixture are disclosed.

### BACKGROUND OF THE INVENTION

Polyetherimides are unique polymers which exhibit superior physical and chemical properties, including high heat resistance, exceptional strength, and excellent processability.

A number of processes for making polyetherimides have been disclosed. Two processes which have been of particular interest are the so-called melt polymerization and solution polymerization processes.

Solution polymerization is generally conducted by reacting an aromatic bis(ether anhydride) and an organic diamine in an inert solvent at elevated temperatures to form an amide-acid polymer via ring opening of the anhydride by nucleophilic attack of the diamine. The polyamide acid is then formed into a polyetherimide by removal of water. With this procedure, water of reaction is typically removed by azeotropic distillation.

Although the foregoing procedures have been used effectively to produce polyetherimides of high quality, they do suffer from certain disadvantages.

Since the water of reaction immediately turns into steam at the temperature of the reaction mass, any increase in the rate of reaction leads to more vigorous releases of water vapor from within the solution contained in the reactor. Consequently, as the rate of reaction increases, the water vapor release becomes increasingly vigorous. Therefore the rate of the solution polymerization reaction needs to be controlled to prevent excessive frothing of the reactor contents and thus avoid an overflow of the reactor contents into associated reactor lines and processing apparatus.

Accordingly, there is a continuing need for an efficient process for producing high quality polyetherimides.

### SUMMARY OF THE INVENTION

Disclosed herein is a process for making polyetherimide, which comprises charging a reactor with a liquid reaction solvent, bisphenol A dianhydride, meta-phenylene diamine and a chain stopper selected from phthalic anhydride and aniline, introducing a stream of dry inert gas below the surface of the liquid reactor contents and selectively removing water from the reactor by dispersing the inert gas within the liquid reactor contents and drawing off the inert gas and water from the headspace of the reactor.

Also disclosed herein, is a process in which the meta-phenylene diamine is added at a rate which produces a reaction rate sufficient to release water from the resultant reaction at a rate which causes excessive foaming of the reactor contents in the absence of the dry inert gas stream.

Disclosed herein is a liquid reaction mixture comprising bisphenol A dianhydride, meta-phenylene diamine and a chain stopper selected from phthalic anhydride and aniline, said mixture further comprising a dry inert gas dispersed therein in an amount sufficient to prevent foaming of the mixture due to vaporization of the water of condensation.

The process presents several benefits, including faster reaction times and reduced losses of reactor contents due to foaming

### BRIEF DESCRIPTION OF THE DRAWINGS

FIG. 1 is a schematic side view of a polymer reaction vessel, 1, having an agitator, 2, coil baffles, 3, nitrogen sparge, 4, and bubbles of nitrogen gas, 5.

### DETAILED DESCRIPTION OF THE INVENTION

Our invention is based, in part, on the observation that by using specific conditions for introducing an inert gas into a reaction mixture at elevated temperatures during polymerization conditions, it is now possible to achieve previously unavailable useful benefits, e.g., more efficient water removal, lower foam generation.

Preferably, the reaction takes place in orthodichlorobenzene (ODCB) under pressure from nitrogen at elevated temperatures. Meta-phenylene diamine is added to the bis-phenol A dianhydride, chain stopper, and orthodichlorobenzene mixture in an agitated 5,000 gallon reactor. The initial contents typically account for about 50% of the reactor volume. The water formed instantly turns into steam vapor due to the temperature of the reaction mass. The steam cannot immediately escape from within the reaction solvent and causes the reactor contents to foam. Although extra vapor space in the reactor may be included in the production design to allow for the foaming nature of the reaction, the rate of reaction and foam generation places a limit on how quickly the m-phenylene diamine can be added and extends the overall batch cycle time.

The present inventors have found that the process of solution polymerization of polyetherimides is improved by introducing an inert gas sparge into the lower portion of the reaction vessel, preferably in a manner which disperses bubbles of the inert gas throughout the reactor. The bubbles of inert gas aid the movement of water vapor out of the reaction solution and reduce frothing of the reaction vessel. This in turn allows an increase in the reaction rate and a shortening of the reaction time required to produce a polyetherimide batch of a given size.

The inert gas is introduced at a rate selected to remove the water vapor released by the reaction and reduce frothing in the reactor. Generally, the inert gas is introduced at a rate from about 10 to about 100 standard cubic feet per meter (scf/m); usually from about 10 to about 50 scf/m; preferably about 20 scf/m. The inert gas sparge can be introduced at single or multiple points within the reaction vessel. In a reaction vessel fitted with a blending aid, such as a mechanical stirrer or agitator, the inert gas is preferably introduced below the level of the blending aid. The blending aid then disperses the bubbles of inert gas within the reactor and provides localized liquid/gas interfaces for release of water vapor from the reaction mixture.

Various numerical ranges are disclosed in this patent application. Because these ranges are continuous, they include every value between the minimum and maximum values. Unless expressly indicated otherwise, the various numerical ranges specified in this application are approximations. The endpoints of all ranges directed to the same component or property are inclusive of the endpoint and independently combinable.

The terms “a” and “an” do not denote a limitation of quantity, but rather denote the presence of at least one of the referenced items. As used herein, “combination thereof” is inclusive of one or more of the recited elements, optionally together with a like element not recited. Reference throughout the specification to “an embodiment,” “another embodiment”, “some embodiments,” and so forth, means that a particular element (e.g., feature, structure, property, and/or characteristic) described in connection with the embodiment is included in at least an embodiment described herein, and may or may not be present in other embodiments. In addition, it is to be understood that the described element(s) can be combined in any suitable manner in the various embodiments.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group. The term “alkyl” includes both C₁₋₃₀ branched and straight chain, unsaturated aliphatic hydrocarbon groups having the specified number of carbon atoms. Examples of alkyl include, but are not limited to, methyl, ethyl, n-propyl, i-propyl, n-butyl, s-butyl, t-butyl, n-pentyl, s-pentyl, n- and s-hexyl, n-and s-heptyl, and, n- and s-octyl. The term “aryl” means an aromatic moiety containing the specified number of carbon atoms and optionally 1 to 3 heteroatoms (e.g., O, S, P, N, or Si), such as to phenyl, tropone, indanyl, or naphthyl.

All molecular weights in this application refer to weight average molecular weights unless indicated otherwise. All such mentioned molecular weights are expressed in Daltons.

All ASTM tests are based on the 2003 edition of the Annual Book of ASTM Standards unless otherwise indicated.

Polyetherimides comprise more than 1, for example 10 to 1000 or 10 to 500 structural units, of formula (1)

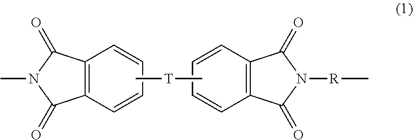

wherein each R is the same or different, and is a substituted or unsubstituted divalent organic group, such as a C₆₋₂₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof, in particular a divalent group of formula (2)

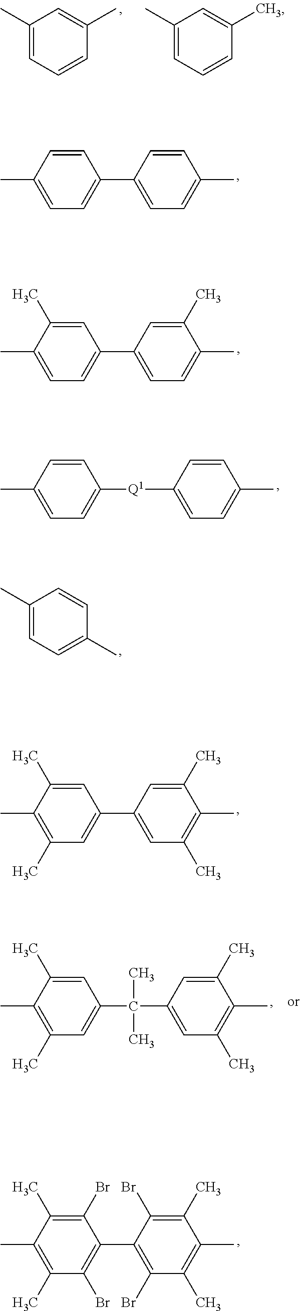

wherein Q¹ is O, S , C(O)—, —SO₂—, —SO—, or —C_{y}H_{2y}— wherein y is an integer from 1 to 5 or a halogenated derivative thereof (which includes perfluoroalkylene groups). In an embodiment R is m-phenylene or p-phenylene.

Further in formula (1), T is —O— or a group of the formula —O—Z—O— wherein the divalent bonds of the —O— or the —O—Z—O— group are in the 3,3′, 3,4′, 4,3′, or the 4,4′ positions. The group Z in formula (1) is the same or different, and is also a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (3):

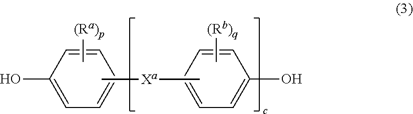

wherein R^{a} and R^{b} can be the same or different and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)−, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

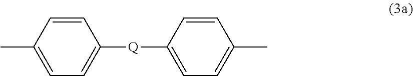

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is derived from bisphenol A wherein Q in formula (3a) is 2,2-isopropylidene.

In an embodiment in formula (1), R is m-phenylene or p-phenylene and T is —O—Z—O wherein Z is a divalent group of formula (3a). Alternatively, R is m-phenylene or p-phenylene and T is —O—Z—O wherein Z is a divalent group of formula (3a) and Q is 2,2-isopropylidene.

In some embodiments, the polyetherimide can be a copolymer, for example, a polyetherimide sulfone copolymer comprising structural units of formula (1) wherein at least 50 mole % of the R groups are of formula (2) wherein Q¹ is —SO₂— and the remaining R groups are independently p-phenylene or m-phenylene or a combination comprising at least one of the foregoing; and Z is 2,2-(4-phenylene)isopropylidene. Alternatively, the polyetherimide optionally comprises additional structural imide units, for example imide units of formula (4)

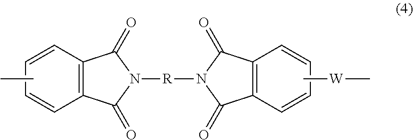

wherein R is as described in formula (1) and W is a linker of the formulas

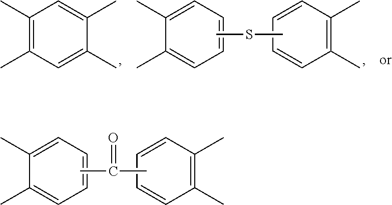

These additional structural imide units can be present in amounts from 0 to 10 mole % of the total number of units, specifically 0 to 5 mole %, more specifically 0 to 2 mole %. In an embodiment no additional imide units are present in the polyetherimide.

The polyetherimide can be prepared by any of the methods well known to those skilled in the art, including the reaction of an aromatic bis(ether anhydride) of formula (5)

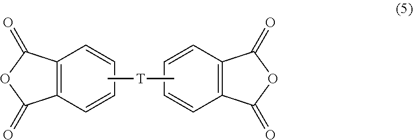

with an organic diamine of formula (6)

H₂N—R—NH₂ (6)

wherein T and R are defined as described above. Copolymers of the polyetherimides can be manufactured using a combination of an aromatic bis(ether anhydride) of formula (5) and a different bis(anhydride), for example a bis(anhydride) wherein T does not contain an ether functionality, for example T is a sulfone.

Illustrative examples of bis(anhydride)s include bisphenol A dianhydride; 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3 -dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, as well as various combinations thereof The preferred (bis)anhydride is bisphenol A dianhydride.

Examples of organic diamines include ethylenediamine, propylenediamine, trimethylenediamine, diethylenetriamine, triethylene tetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl)amine, 3-methoxyhexamethylenediamine, 1,2-bis(3-aminopropoxy)ethane, bis(3 -aminopropyl)sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl)methane, bis(2-chloro-4-amino-3,5-diethylphenyl)methane, bis(4-aminophenyl)propane, 2,4-bis(p-amino-t-butyl)toluene, bis(p-amino-t-butylphenyl)ether, bis(p-methyl-o-aminophenyl)benzene, bis(p-methyl-o-aminopentyl)benzene, 1,3-diamino-4-isopropylbenzene, bis(4-aminophenyl)sulfide, bis-(4-aminophenyl)sulfone, and bis(4-aminophenyl)ether. Combinations of these compounds can also be used. The preferred organic diamine is m-phenylenediamine

Monofunctional reactants such as phthalic anhydride or aniline are employed as a chain stopper to control molecular weight of the polyetherimide polymer. Polymer chains which terminate in such a monofunctional reactant chain stopper are also referred to as end-capped polymer chains. The chain stopper is therefore alternately referred to as an end cap or molecular weight control additive.

The reaction solvents employed for solution polymerization reactions are selected for their solvent properties and their compatibility with the reactants and products. The solvent can be an inert organic solvent that does not deleteriously affect the reaction. Relatively high-boiling, nonpolar solvents are preferred, and examples of such solvents are benzene, toluene, xylene, ethylbenzene, propylbenzene, chlorobenzene, dichlorobenzenes, trichlorobenzenes, biphenyl, terphenyl, diphenylether, diphenyl sulfide, acetophenone, chlorinated biphenyl, chlorinated diphenylethers, dichloroethane, tetrachloroethane, trichloroethylene, tetrachloroethylene, methylcyclohexane, octane, isooctane, decane, and the like.

Mixtures of such solvents can also be employed. A particularly preferred solvent is o-dichlorobenzene. Sufficient solvent is generally utilized to provide a solids content in the range between 1% and 90%, preferably in the range between about 15% and about 60%.

The aromatic dianhydride and organic diamine may be present in the solvent in substantially equimolar amounts (described herein as producing an equimolar polyetherimide) or with the amine or anhydride in molar excess (described herein as producing an amine or anhydride terminated polyetherimide). The term “substantially equimolar amounts” is herein defined as a molar ratio of aromatic dianhydride to organic diamine of about 0.9 to about 1.1, preferably about 0.95 to about 1.05 and more preferably about 0.98 to about 1.02. When the reaction mixture contains an excess of aromatic dianhydride a polyetherimide predominantly terminated with anhydride groups results. When the reaction mixture contains an excess of an organic diamine a polyetherimide predominantly terminated with amine groups results. Typical molar excess can be described by a molar ratio of aromatic dianhydride to organic diamine or organic diamine to organic dianhydride of less than or equal to about 26, preferably less than or equal to about 20 and more preferably less than or equal to about 15 or greater than or equal to about 2, preferably greater than or equal to about 5 and more preferably greater than or equal to about 10.

The reaction of the aromatic dianhydride and the organic diamine may optionally be accelerated by using a polymerization catalyst. Such catalysts are well-known and are described in general terms in the U.S. Pat. Nos. 3,833,544, 3,998,840, and 4,324,882. When employed, the amount of catalyst is about 0.01 to about 0.05 grams of catalyst per one hundred grams of aromatic dianhydride.

The reaction between the aromatic dianhydride and the organic diamine is initiated by heating the reactants in the solvent to a temperature sufficiently high to effect the reaction. To avoid deleterious oxidation reactions, it is preferred that the reaction solution be blanketed under an inert gas during the heating step. Examples of such gases are dry nitrogen, helium, argon and the like. Dry nitrogen is generally preferred. The reaction can be run at atmospheric to superatmospheric pressure. The reaction temperature generally is about 110° C. to about 200° C., preferably about 135° C. to about 180° C., most preferably about 160° C. to about 180° C. A convenient means of conducting the reaction is to heat the reaction solution to the refluxing temperature of the reaction solvent. This permits simultaneous removal of any water formed as a result of the reaction. Conditions under which the reaction proceeds and the water formed as a result of the reaction is removed are known as imidization conditions. The reaction is maintained under imidization conditions until the desired polymer is produced.

Water formed as a result of the reaction between the aromatic dianhydride and the organic diamine is advantageously continuously removed from the reaction solvent by azeotropic distillation. Substantially complete distillation of the water of reaction is defined as removal of greater than or equal to about 98%, preferably greater than or equal to about 99%, more preferably greater than or equal to about 99.5% and even more preferably greater than or equal to about 99.9%. The amount of water formed can be used to monitor the degree of completion of the reaction.

Polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide polymer has a weight average molecular weight (Mw) of 1,000 to 150,000 grams/mole (Dalton), as measured by gel permeation chromatography, using polystyrene standards. In some embodiments the polyetherimide has Mw of 10,000 to 80,000 Daltons. Such polyetherimide polymers typically have an intrinsic viscosity greater than 0.2 deciliters per gram (dl/g), or, more specifically, 0.35 to 0.7 dl/g as measured in m-cresol at 25° C.

In an embodiment, the polyetherimide comprises less than 50 ppm amine end groups. In other instances the polymer will also have less than 1 ppm of free, unpolymerized bisphenol A (BPA).

The polyetherimides can have low levels of residual volatile species, such as residual solvent and/or water. In some embodiments, the polyetherimides have a residual volatile species concentration of less than 1000 parts by weight per million parts by weight (ppm), or, more specifically, less than 500 ppm, or, more specifically, less than 300 ppm, or, even more specifically, less than 100 ppm. In some embodiments, the composition has a residual volatile species concentration of less than 1000 parts by weight per million parts by weight (ppm), or, more specifically, less than 500 ppm, or, more specifically, less than 300 ppm, or, even more specifically, less than 100 ppm.

Low levels of residual volatile species in the final polymer product can be achieved by known methods, for example, by devolatilization or distillation. In some embodiments the bulk of any solvent can be removed and any residual volatile species can be removed from the polymer product by devolatilization or distillation, optionally at reduced pressure. In other embodiments the polymerization reaction is taken to some desired level of completion in solvent and then the polymerization is essentially completed and most remaining water is removed during at least one devolatilization step following the initial reaction in solution. Apparatuses to devolatilize the polymer mixture and reduce solvent and other volatile species to the low levels needed for good melt processability are generally capable of high temperature heating under vacuum with the ability to rapidly generate high surface area to facilitate removal of the volatile species. The mixing portions of such apparatuses are generally capable of supplying sufficient power to pump, agitate, and stir the high temperature, polyetherimide melt which can be very viscous. Suitable devolatilization apparatuses include, but are not limited to, wiped films evaporators, for example those made by the LUWA Company and devolatilizing extruders, especially twin screw extruders with multiple venting sections, for example those made by the Werner Pfleiderer Company or Welding Engineers.

In an embodiment, the polymer-solvent mixture from the solution polymerization step is subjected to a second process step, wherein the mixture is formed into a thin film under solvent-volatilizing conditions to effect substantially complete solvent and water removal. This step can advantageously be conducted in a continuous manner using conventional thin-film evaporation equipment. Such equipment can take a variety of forms, and the process of the present invention is not limited to any particular form of equipment. Typical thin-film evaporation equipment consists of a heated, large-diameter, cylindrical or tapered tube in which is rotated a series of wipers, either maintaining a fixed close clearance from the wall or riding on a film of liquid on the wall. The continuous forming and reforming of the film permits concentration of viscous materials. Reduced pressure may be employed to accelerate solvent removal, and an evaporation temperature of from about 200° C. to about 450° C. preferably from about 250° C. to about 350° C. is employed. Lower temperatures result in very viscous mixtures, which are difficult to process and can damage equipment, whereas higher temperatures can cause decomposition of the product. Thin-film evaporation permits efficient solvent recovery, which is advantageous from both economical and ecological standpoints.

Typically, the polymer-solvent mixture is a product mixture obtained after a polymerization reaction conducted in a solvent. For example, the polymer-solvent mixture may be the product of the condensation polymerization of bisphenol A dianhydride (BPADA) with m-phenylenediamine in the presence of phthalic anhydride chainstopper in ODCB. In cases where a water soluble catalyst is employed, the catalyst can be removed prior to any polymer isolation step. Thus, the product polyetherimide solution in ODCB is washed with water and the aqueous phase is separated to provide a water washed solution of polyetherimide in ODCB. Methods for removing polyetherimide from solvent are known to those of ordinary skill in the art and are disclosed in detail in U.S. Pat. No. 7,226,989.

It is often useful to melt filter the polyetherimide using known melt filtering techniques to remove foreign material, carbonized particles, cross-linked resin, or similar impurities. Melt filtering can occur during initial resin isolation or in a subsequent step. The polyetherimide can be melt filtered in the extrusion operation. Melt filtering can be performed using a filter with a pore size sufficient to remove particles with a dimension of greater than or equal to 100 micrometers or with a pore size sufficient to remove particles with a dimension of greater than or equal to 40 micrometers.

Reaction time for the process can vary from about 0.5 to about 20 hours, depending upon such factors as batch size, the temperature employed, degree of agitation, nature of reactants, solvent, and the like. In an embodiment, the reaction cycle time is from 3 to 4 hours. The addition of the dry inert gas stream to a given reaction scheme allows a faster rate of addition of the diamine without frothing the reaction mixture over a given control level and produces a reduction in the reaction cycle time.

In an embodiment, the reaction cycle time is reduced by 7% for phthalic anhydride end-capped resin and 20% for aniline end-capped resin compared to a process without the dry inert gas stream.

In an embodiment, the production of the reactor is increased by 7% for phthalic anhydride end-capped resin and 20% for aniline end-capped resin in a production day compared to a process without the inert gas stream.

The reaction step can be conveniently monitored by measuring the intrinsic viscosity of the polymer that is produced. Generally, higher intrinsic viscosities, indicate greater degrees of polymerization. The first reaction step is preferably conducted to an intrinsic viscosity of at least about 0.25 dl/g, preferably at least about 0.30 dl/g. During the course of the reaction, water of reaction is removed. The amount of water generated, as a percentage of theoretical, can also be used to monitor the course of the reaction.

The present process overcomes the disadvantages of solution polymerization processes. The lengthy reaction times and incomplete reactions associated with solution polymerizations are avoided by the solvent removal and high-temperature processing.

The invention is further illustrated by the following examples, which are not intended to be limiting.

### EXAMPLES

Following is a list of materials, acronyms, and selected sources used in the examples.

Materials

| Material | Description | Source |
|---|---|---|
| BPA-DA | Bisphenol A dianhydride, | SABIC Internal |
| | monomer to make | |
| | polyetherimide | |
| MPD | m-phenylene diamine, | Dupont and Amino Chem |
| | monomer to make | |
| | polyetherimide | |
| PA | Phthalic Anhydride, | Koppers, Inc. |
| | chainstopper/end cap for | |
| | polyetherimide | |
| Aniline | Aniline, chainstopper/end | DuPont |
| | cap for polyetherimide | |
| ODCB | Ortho Dichlorobenzene, | Amino Chem |
| | Solvent | |
| Nitrogen | Supplied via a plant header | Air Liquide |
| Reactor | Batch Polymer Reactor | SABIC Internal |
| Reactor Baffles | Steam coil baffles for | SABIC Internal |
| | increased heat transfer to | |
| | reactor | |
| Reactor Agitator | Mixes reactor contents | SABIC Internal |
| Rotameter | Gas flow meter to measure | Brooks, Inc. |
| | nitrogen flow and valve to | |
| | control flow | |

### Techniques & Procedures

### Procedure for Making Polyetherimide

The reaction of MPD (m-phenylene diamine) and BPA-DA (Bis-phenol A dianhydride) to form polyetherimide is a condensation reaction that liberates water. A solution of BPA-DA (monomer 1) dissolved in roughly equal parts of ODCB at about 140° C. is charged to the polymer reaction vessel (5,000 gallons). End cap (PA or aniline) was added to the batch to control average chain length and polymer melt index (viscosity). Molten MPD (monomer 2) was added to the reactor. The water of the reaction formed instantly and turned into steam vapor due to the temperature of the reaction mass and caused the reactor contents to foam. By design, the reactants were kept at about 50% of the polymer reactor volume to allow for foaming and liquid/vapor disengagement. The original polymer reaction vessel level detector was a differential pressure measurement that could not detect the foam level. If not monitored, the polymer reaction vessel foaming would push the reactor contents overhead and cause operational issues. Foam level was measured with a nuclear level detector. Molten MPD addition was interlocked to keep the foam level at or below 92% of the level between the tangent lines of the reaction vessel.

As the reaction proceeds, molecular weight increased and the reaction mixture became more viscous. As a result, it was harder for the water that is formed to escape the reaction mass. To compensate for this, the MPD Addition Recipe incorporated stepwise reduction in MPD addition rate as the batch proceeded. Based off of pilot trials, the MPD Addition Recipe optimized to the following set points, shown in Table 1.

TABLE 1
PA end capped batch MPD Addition Recipe

| | | End Point | |
|---|---|---|---|
| | Set Point | Lbs | Add Ph. Temp |
| | lbs/min | (Cumulative lbs) | deg C. |
| 1st Stage | 47 | 2300 | 160 |
| 2nd Stage | 20 | 2600 | 165 |
| 3rd Stage | 10 | 3200 | 172 |
| 4th Stage | 10 | 3200-3300 | 172 |
| 5th Stage | 10 | 3200-3300 | 172 |
| 6th Stage | 10 | 3200-3300 | 172 |

Aniline end capped batches historically have generated more foam. This necessitated the MPD addition recipe below in Table 2. Note the rate at which MPD can be added was less. This reduced the effective plant capacity to about 85% in this grade.

TABLE 2
Aniline end capped batch MPD Addition Recipe

| | | End Point | |
|---|---|---|---|
| | Set Point | Lbs | Add Ph. Temp |
| | lbs/min | (Cumulative lbs) | deg C. |
| 1st Stage | 34 | 2300 | 163.5 |
| 2nd Stage | 17 | 2450 | 172 |
| 3rd Stage | 6.7 | 2600 | 172 |
| 4th Stage | 6.7 | 3200-3300 | 172 |
| 5th Stage | 6.7 | 3200-3300 | 172 |
| 6th Stage | 6.7 | 3200-3300 | 172 |

After all of the MPD was added, the batch was agitated for 1 hour and was then sampled. The sample was analyzed to determine if it was on target, anhydride rich, or amine rich. Adjustments were made to make the polymer slightly anhydride rich. When the batch had the correct stoichiometry, it was transferred to a surge tank and then devolitalized (removed solvent). The polymer reactor contents continued to heat up during the batch and increased to about 170° C. Past experience has shown that the processing issues result if the batch was transferred forward before it had reached a minimum temperature. A permissive to transfer the batch was set at 167° C.

### Procedure for Making Polyetherimide Optimal Temperature

The ingredients of the examples shown in the above tables were reacted at lower temperatures. Through pilot trials, the MPD addition recipe setpoints were adjusted to the values in the table below.

TABLE 3
MPD Addition Recipe for Optimal Temperature

| | | End Point | |
|---|---|---|---|
| | Set Point | Lbs | Add Ph. Temp |
| | lbs/sec | (Cumulative lbs) | deg C. |
| 1st Stage | 47 | 2300 | 160 |
| 2nd Stage | 20 | 2600 | 162 |
| 3rd Stage | 10 | 3200 | 169 |
| 4th Stage | 10 | 3200-3300 | 169 |
| 5th Stage | 10 | 3200-3300 | 169 |
| 6th Stage | 10 | 3200-3300 | 169 |

Further lowering the temperature set points increased the amount of time it took to reach the minimum drop temperature of 167° C. and increased the batch cycle time.

### Procedure for Applying Nitrogen Into System

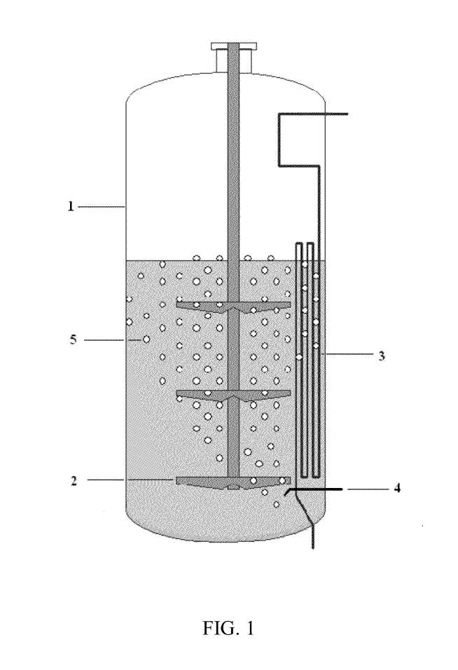

Plant nitrogen was added to the reactor contents subsurface and below the bottom set of agitator blades. Nitrogen was added at 20 SCFM (Standard Cubic Feet per Minute). The amount of nitrogen was measured with a local rotameter. The nitrogen sparge rate can be manually adjusted with a valve. To prevent pluggage of the subsurface nitrogen piping, the nitrogen flows all of the time. Process vent capacity was not an issue. Raw material charges for each batch were monitored to ensure no additional losses due to the nitrogen sweep. FIG. 1 is a scale schematic of the polymer reactor following the addition of the nitrogen sparge.

After the addition of the nitrogen sparge, we were able to run both PA and Aniline end capped resin at the same recipe as shown in Table 4. The expansion of the nitrogen and evaporation of ODCB reduced the bulk temperature of the reactor. In the first pilot trials, the previous settings were used and we were not able to reach the minimum batch drop temperature. The reactor temperature setpoints were also increased throughout the batch. Additionally, pilot trials were completed to lower the minimum polymer reactor drop temperature to 165° C.

TABLE 4
MPD Addition Recipe for PA and Aniline End Capped
Resin with Nitrogen Sparge

| | | End Point | |
|---|---|---|---|
| | Set Point | Lbs | Add Ph. Temp |
| | Lbs/min | (Cumulative lbs) | deg C. |
| 1st Stage | 47 | 2300 | 169 |
| 2nd Stage | 20 | 2600 | 169 |
| 3rd Stage | 10 | 2800 | 169 |
| 4th Stage | 10 | 3200-3300 | 169 |
| 5th Stage | 10 | 3200-3300 | 169 |
| 6th Stage | 10 | 3200-3300 | 169 |

It was determined through lab measurements that more ODCB (ortho dichlorobenzene) was removed from the reactor as vapor. To compensate for this, the initial ODCB charge was increased to keep the viscosity at the end of the batch cycle in the acceptable range.

### Testing Procedures

Each batch was analyzed in the lab to determine if it had the correct stoichiometry. If the batch was within the stoichiometry target range, nothing was added. MPD or BPA-DA can be added to reach the stoichiometry target. Analysis of the samples before and after the introduction of the nitrogen sparge showed no extra monomers were sent overhead.

Each batch was analyzed in the lab to determine the percentage polymer (solids) in the reaction mass. An increase in the percent solids was noticed after the nitrogen sparge was put into service. This was an indication that more ODCB was leaving the polymer reaction vessel as vapor. This was not an issue when making lower molecular weight (lower viscosity) batches, but led to major processing issues when making higher molecular weight (higher viscosity batches). To compensate for this more ODCB was added at the beginning of the batch.

### Results

TABLE 5

| | | Batch | |
|---|---|---|---|
| | | Cycle | % Increase |
| | lbs./day/reactor | Time | Capacity |
| Aniline End Capped Base Line | 85,000 | 4.8 | N/A |
| Aniline Batch Post Nitrogen Sparge | 102,000 | 4 | 20 |
| PA End Capped Base Line | 91,480 | 4.46 | N/A |
| PA End Capped Temp Optimization | 102,000 | 4 | 12 |
| 1010 End Capped Nitrogen Sparge | 108,800 | 3.75 | 7 |
| 1000 End Capped Nitrogen | 108,800 | 3.75 | 7 |
| Sparge-Temperature | | | |

In PA end capped resin, the following MPD addition recipe was run.

TABLE 6

| | | End Point | |
|---|---|---|---|
| | Set Point | Lbs | Add Ph. Temp |
| | Lbs/min | (Cumulative lbs) | deg C. |
| 1st Stage | 47 | 2300 | 169 |
| 2nd Stage | 20 | 2600 | 169 |
| 3rd Stage | 10 | 2800 | 169 |
| 4th Stage | 10 | 3200-3300 | 169 |
| 5th Stage | 10 | 3200-3300 | 169 |
| 6th Stage | 10 | 3200-3300 | 169 |

The polymer reaction vessel agitator speed is adjusted and maintained to allow thorough dispersion of the nitrogen and mixing of the polymer reaction vessel contents.

In Aniline end capped resin, the following MPD addition recipe produces batches with reduced (less than 4 hour) batch cycle times.

TABLE 7

| | | End Point | |
|---|---|---|---|
| | Set Point | Lbs | Add Ph. Temp |
| | lbs/min | (Cumulative lbs) | deg C. |
| 1st Stage | 47 | 2500 | 165 |
| 2nd Stage | 17 | 2600 | 165 |
| 3rd Stage | 9 | 3200 | 169 |
| 4th Stage | 9 | 3200-3300 | 169 |
| 5th Stage | 9 | 3200-3300 | 169 |
| 6th Stage | 9 | 3200-3300 | 169 |

### Discussion

The purpose of this experiment was to reduce the necessary cycle time to react dianhydrides and diamines to make polyetherimide. This reaction was a condensation reaction that generated water. The reactants and polymer formed were in an organic solvent above the boiling point of water. The water was instantly turned to vapor and caused the reactor contents to foam. Too much foam will limit the rate the reactants can be combined and increase overall batch cycle time.

Without a nitrogen sparge, precise temperature control was required to maintain optimal batch performance. If the temperature was too high, the reaction rate was too fast and the contents generated foam and extended the amount of time to combine all reactants. When the reaction mixture temperature was too low, it took longer to get to the minimum temperature to complete the batch.

A subsurface nitrogen sparge reduced the batch cycle time by removing the water generated more effectively. The nitrogen provided additional surface area for the water vapor to escape and increased mass transfer of the water from the reaction mixture.

Our results indicate that the use of the nitrogen sparge in accordance to our invention increases the rate at which polyetherimide can be produced. The final product is equivalent. Through trials we have found a range where we can effectively remove the water without yield losses due to entraining monomers. Using a reactor commensurate to the reactor shown in FIG. 1, following the implementation of the nitrogen sparge and optimization trials, aniline end capped resin capacity was increased from about 85,000 lbs./day/reactor to greater than 100,000 lbs./day/reactor (4.8 hours batch cycle time to less than 4 hours) and PA end capped resin capacity was increased from about 102,000 lbs./day/reactor to about 109,000 lbs./day/reactor (4 hours batch cycle time to 3.75 hours) allowing sprint capacity at maximum plant rates. Additionally, the repeatability of the batches increased, and the batches were less sensitive to temperature changes.

All cited patents, patent applications, and other references are incorporated herein by reference in their entirety.

Although the present invention has been described in detail with reference to certain preferred versions thereof, other variations are possible. Therefore, the spirit and scope of the appended claims should not be limited to the description of the versions contained therein.

What is claimed is:

1. A process for preparing a polyetherimide resin comprising charging a reactor with a liquid reaction solvent, bisphenol A dianhydride, meta-phenylene diamine and a chain stopper selected from phthalic anhydride and aniline, introducing a stream of dry inert gas below the surface of the liquid reactor contents and selectively removing water from the reactor by dispersing the inert gas within the liquid reactor contents and drawing off the inert gas and water from the headspace of the reactor, thereby preparing the polyetherimide resin.

2. The process of claim 1, wherein the meta-phenylene diamine is added at a rate which produces a reaction rate sufficient to release water from the resultant condensation reaction at a rate which causes excessive foaming of the reactor contents in the absence of the dry inert gas stream.

3. The process of claim 1, wherein the reaction contents do not foam above a preset control level.

4. The process of claim 1, wherein the reaction cycle time is reduced by 7% for phthalic anhydride end-capped resin and 20% for aniline end-capped resin compared to a process without the dry inert gas stream.

5. The process of claim 1, wherein the production of the reactor is increased by 7% for phthalic anhydrid end-capped resin and 20% for aniline end-capped resin in a production day compared to a process without the inert gas stream.

6. The process of claim 1, wherein the reactor volume is 5,000 gallons and the inert gas is nitrogen introduced at 10 to 50 standard cubic feet per minute.

7. The process of claim 1, wherein the reactor volume is 5,000 gallons and the inert gas is nitrogen introduced at 20 standard cubic feet per minute.

8. The process of claim 1, wherein the reaction solvent is ortho-dichlorobenzene.

9. The process of claim 1, wherein the reaction temperature ranges from 110° C. to 200° C.

10. The process of claim 1, wherein the polyetherimide is prepared at a rate that is greater than 85,000 lbs./day/reactor.

11. The process of claim 1, wherein the polyetherimide is prepared at a rate that is greater than 100,000 lbs./day/reactor.

12. The process of claim 1, wherein the polyetherimide is prepared at a rate ranging from 85,000 to 100,000 lbs./day/reactor.

13. A liquid reaction mixture comprising bisphenol-A dianhydride, meta-phenylene diamine and a chain stopper selected from phthalic anhydride and aniline, said mixture further comprising a dry inert gas dispersed therein in an amount sufficient to prevent foaming of the mixture due to vaporization of the water of condensation.

14. The liquid reaction mixture of claim 13, wherein the reactor volume is 5,000 gallons and the inert gas is nitrogen introduced at 10 to 50 standard cubic feet per minute.
